(19) United States
(12) Patent Application Publication
(10) Pub. No.: US 2018/0106438 A1
(43) Pub. Date: Apr. 19, 2018

(54) ILLUMINATING SAFETY NET

(71) Applicant: NICAUD COMPANIES 22 (PTY) LTD., Rustenburg (ZA)

(72) Inventor: Brendan Robert CROMPTON, Rustenburg (ZA)

(21) Appl. No.: 15/730,873

(22) Filed: Oct. 12, 2017

(30) Foreign Application Priority Data
Oct. 13, 2016 (ZA) 2016/07044

(51) Int. Cl. F21S 4/15; E01F 7/04

(52) U.S. Cl. CPC F21S 4/15; E01F 7/045

(57) ABSTRACT

Disclosed is an illuminating safety net which includes a net body which has a quadrilateral perimeter of elongate tensile members, and a plurality of elongate tensile elements attached to the perimeter and extending within the perimeter in at least two transverse directions; and an elongate flexible lighting strip engaged to the net body along at least part of a perimeter edge of the perimeter.

### BACKGROUND OF THE INVENTION

The invention relates to an illuminating safety net.

Lighting is an issue in underground mine excavations. To provide adequate lighting, particularly in the working areas or stopes of the mine, requires a complex electrical installation of bulbs, power lines, means to attach and suspend the bulbs and power lines and intermittent accessible electricity supply points.

In a typical lighting system, a string of bulbs is suspended from a wall of the excavation, interlinked by a power cable. The bulbs are interspersed on this cable at intervals that create an uneven lighting pattern.

The current invention at least partially solves the aforementioned problem.

### SUMMARY OF INVENTION

The invention provides an illuminating safety net which includes a net body which has a quadrilateral perimeter of elongate tensile members, and a plurality of elongate tensile elements attached to the perimeter and extending within the perimeter in at least two transverse directions; and an elongate flexible lighting strip engaged to the net body along at least part of a perimeter edge of the perimeter.

The flexible lighting strip may include at least one length of flexible plastic tubing, and a string of electrically interlinked LEDs in the tubing and a connector terminal or power supply connector at one end of the string of LEDs.

Preferably, the lighting strip extends about the entire perimeter edge of the net.

The safety net may include an attachment means for attaching the lighting strip to the net body.

The attachment means may be a plurality of attachment loops, each of which presents laterally of the perimeter. The lighting strip may be threaded through each of the loops in engagement of the lighting strip to the net body.

Alternatively, the lighting strip may be tied or fastened to the safety net by any suitable means, for example, by using a plurality of cable ties or the like.

### BRIEF DESCRIPTION OF THE DRAWINGS

The invention is described with reference to the following drawings in which:

FIG. 1 illustrates, in plan, an illuminating safety net in accordance with the invention; and

FIG. 2 illustrates a length of lighting tube which is attached to the perimeter of a body of the safety net.

### DESCRIPTION OF PREFERRED EMBODIMENTS

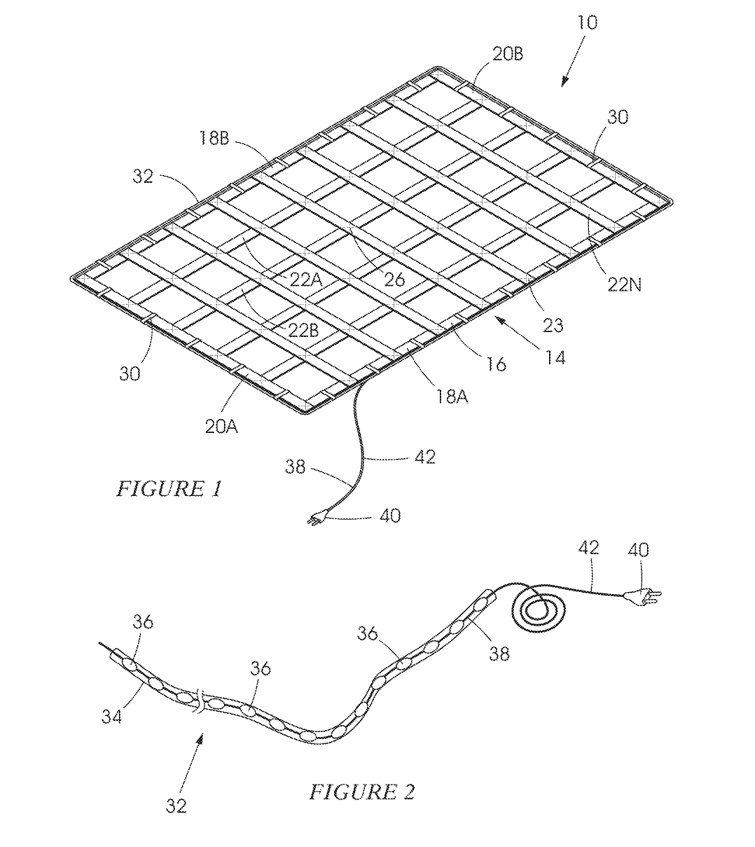

FIG. 1 illustrates an illuminating safety net 10, in accordance with the invention, which is installed, with the aid of hooks (not shown) to preinstalled support (not shown), which is engaged to a hanging wall (not shown) of a mine excavation, to prevent rock fall from the hanging wall harming a mine worker beneath.

This particular net however, serves an additional function: that of illuminating the area beneath the safety net which, in the mine excavation, is an active work area.

This safety net 10 has a quadrilateral mesh body 14 defined by a perimeter 16 which is comprised of a pair of longitudinal members, respectively designated 18A and 18B and a pair of transverse members, respectively designated 20A and 20B.

Within the perimeter, the body 14 includes a grid of elongate tensile elements which extend in a first direction, parallel to the transverse members 20, and a second direction, parallel to the longitudinal members 18. These elements are designated, in no particular order, 22A, 22B . . . 22N. Each element intersects and engages with a member (18, 20) at an attachment location 23.

The elements 22 cross one another at overlap points 26. At the overlap points, the intersecting elements are stitched together or otherwise secured together by any other suitable means.

The elements (22, 24) and the members (18, 20) are straps of a suitable tensile fabric material.

In this particular example, the safety net 10 includes a plurality of attachment loops 30 extending transversely from the perimeter 16 and spaced at regular intervals along each member (18, 20).

The safety net 10 includes a lighting tube 32 which, in this example, runs along the entire perimeter 16 and which is attached thereto by being threaded through each loop 30.

In this example, the lighting tube 32 consists of a single length of flexible plastic tubing 34 and a plurality of LEDs 36 that are electrically interlinked by a power supply line 38. The LEDs can be connected in series or parallel. The power supply line terminates at one end, in a power source connector or plug 40. However it is anticipated, within the scope of this invention, that the lighting tube comprises a plurality of lengths, each length electrically connectable to a preceding or following length.

The plastic tubing 34 will be of a suitable plastic material that is protective to the LEDs contained therein, excluding the ingress of dirt and debris, whilst being flexible and sufficiently translucent or transparent so as not to absorb any of the light emanating from the LEDs.

The benefit of the illuminating safety net 10 is that it is a flexible structure, capable of being folded or rolled prior to installation, with the lighting tube hindering the folded or rolled configuration. When the net is required, it is unfolded or unrolled, elevated to the hanging wall and attached to preinstalled support as mentioned above. Then, to provide the secondary function of light, the plug 40, at a trailing end section 42 of the power line 38, is merely plugged into the nearest available power source portal.

Furthermore, below the installed net, the work area is more evenly and brightly lit.

1. An illuminating safety net which includes a net body which has a quadrilateral perimeter of elongate tensile members, and a plurality of elongate tensile elements attached to the perimeter and extending within the perimeter in at least two transverse directions; and an elongate flexible lighting strip engaged to the net body along at least part of a perimeter edge of the perimeter.

2. An illuminating safety net according to claim 1 wherein the flexible lighting strip includes at least one length of flexible plastic tubing, a string of electrically interlinked LEDs in the tubing and a connector terminal or power supply connector at one end of the string of LEDs.

3. An illuminating safety net according to claim 1 wherein the lighting strip extends about the entire perimeter edge of the net.

4. An illuminating safety net according to claim 1 wherein the safety net includes an attachment means for attaching the lighting strip to the net body.

5. An illuminating safety net according to claim 4 wherein the attachment means is a plurality of attachment loops, each of which presents laterally of the perimeter.

6. An illuminating safety net according to claim 1 wherein the lighting strip is tied or fastened to the safety net.

7. An illuminating safety net according to claim 2 wherein the lighting strip extends about the entire perimeter edge of the net.

8. An illuminating safety net according to claim 2 wherein the safety net includes an attachment means for attaching the lighting strip to the net body.

9. An illuminating safety net according to claim 3 wherein the safety net includes an attachment means for attaching the lighting strip to the net body.

10. An illuminating safety net according to claim 7 wherein the safety net includes an attachment means for attaching the lighting strip to the net body.

11. An illuminating safety net according to claim 2 wherein the lighting strip is tied or fastened to the safety net.

12. An illuminating safety net according to claim 3 wherein the lighting strip is tied or fastened to the safety net.

13. An illuminating safety net according to claim 7 wherein the lighting strip is tied or fastened to the safety net.
